(19) United States
(12) Patent Application Publication
(10) Pub. No.: US 2023/0068700 A1
(43) Pub. Date: Mar. 2, 2023

(54) System, Method, and Computer Program Product for Transaction Based Activation

(71) Applicant: Visa International Service Association, San Francisco, CA (US)

(72) Inventor: Deepak Kumar Tomar, Fremont, CA (US)

(21) Appl. No.: 17/458,762

(22) Filed: Aug. 27, 2021

(51) Int. Cl. G06Q 20/38; H04L 29/06; G06F 16/2455

(52) U.S. Cl. CPC G06Q 20/3821; H04L 63/083; G06F 16/2455

(57) ABSTRACT

A system, method, and computer program product are provided for card activation. The method includes registering, during an enrollment process, an account for a user by associating the user with a communication channel outside of an electronic payment processing network; associating the user with an inactivated account identifier; receiving, via the electronic payment processing network, a transaction request message corresponding to a transaction initiated at a merchant system by the user with a payment device issued with the inactivated account identifier; in response to receiving the transaction request message, communicating a credential to the user; receiving the credential; authenticating the user based on comparing the credential received via the electronic payment processing network to the credential communicated to the user via the communication channel; in response to authenticating the user, activating the account identifier; and processing the transaction with the activated account identifier after the account identifier has been activated.

### BACKGROUND

### 1. Field

The present invention relates to activation of an account identifier and, in non-limiting embodiments or aspects, to a system, method, and computer program product for activating an account identifier with a transaction request.

### 2. Description of Related Art

Account identifiers, such as primary account numbers (PANs) associated with credit cards or other payment methods, are often communicated to users through the use of mail. This has made mail often a target for fraudsters who attempt to intercept the account information before it gets to the user. These fraudsters may then be able to activate the account identifier and use the account identifier to make fraudulent purchases. Traditional methods of activating an account identifier may be cumbersome for users, and use additional computing resources. Therefore, there is a need for a way to streamline the activation process for better user experience and reduction in computing resources.

### SUMMARY

According to non-limiting embodiments or aspects, provided is a method including registering, during an enrollment process, an account for a user by associating the user with a communication channel outside of the electronic payment processing network; associating the user with an inactivated account identifier; receiving, via an electronic payment processing network, a transaction request message corresponding to a transaction initiated at a merchant system by the user with a payment device issued with the inactivated account identifier; in response to receiving the transaction request message corresponding to the inactivated account identifier, communicating a credential to the user via the communication channel outside of the electronic payment processing network; receiving, from the user, the credential via the electronic payment processing network; authenticating the user based on comparing the credential received via the electronic payment processing network to the credential communicated to the user via the communication channel; in response to authenticating the user, activating the account identifier; and processing the transaction with the activated account identifier after the account identifier has been activated.

In non-limiting embodiments or aspects, the method may further comprise determining the account associated with the user is enrolled in a transaction activation process and communicating the credential to the user in response to determining the account is enrolled in the transaction activation process. The method may further comprise associating the user with a second inactivated account identifier; receiving, via the electronic payment processing network, a second transaction request message corresponding to a second transaction initiated by the user with the second inactivated account identifier; in response to receiving the second transaction request message corresponding to the second inactivated account identifier, communicating a second credential to the user via the communication channel outside of the electronic payment processing network; receiving, from the user, the second credential via the electronic payment processing network; authenticating the user based on comparing the second credential received via the electronic payment processing network to the second credential communicated to the user via the communication channel; in response to authenticating the user, activating the second account identifier; and processing the transaction with the second activated account identifier after the second account identifier has been activated.

In non-limiting embodiments or aspects, the method may further comprise determining that the account identifier is not associated with a prior transaction request and communicating the credential to the user in response to determining that the account identifier is not associated with a prior transaction request. Determining the account identifier is not associated with the prior transaction request may further comprise searching an account database for account data associated with the account identifier; determining that the account data comprises transaction data associated with a transaction request; and identifying the account identifier is not associated with the prior transaction request in response to determining the account data does not include transaction data associated with a transaction request. Determining that the account identifier is not associated with the prior transaction request may further comprise amending the account database to include transaction data associated with the transaction request message if the account identifier is not associated with the prior transaction request. The method may further comprise in response to determining the account identifier is not associated with the prior transaction request, determining if the account is registered into a transaction activation process; and in response to determining the account is registered into the transaction activation process, communicating the credential to the user.

According to other non-limiting embodiments or aspects, provided is a system for processing transactions, the system comprising at least one server computer including at least one processor, the at least one server computer programmed and/or configured to: register, during an enrollment process, an account for a user by associating the user with a communication channel outside of the electronic payment processing network; associate the user with an inactivated account identifier; receive, via an electronic payment processing network, a transaction request message corresponding to a transaction initiated at a merchant system by the user with a payment device issued with the inactivated account identifier; in response to receiving the transaction request message corresponding to the inactivated account identifier, communicate a credential to the user via the communication channel outside of the electronic payment processing network; receive, from the user, the credential via the electronic payment processing network; authenticate the user based on comparing the credential received via the electronic payment processing network to the credential communicated to the user via the communication channel; in response to authenticating the user, activate the account identifier; and process the transaction with the activated account identifier after the account identifier has been activated.

In non-limiting embodiments or aspects, the at least one server computer may be programed and/or configured to: determine the account associated with the user is enrolled in a transaction activation process; and communicate the credential to the user in response to determining the account is enrolled in the transaction activation process. The at least one server computer may be programed and/or configured to: associate the user with a second inactivated account identifier; receive, via the electronic payment processing network, a second transaction request message corresponding to a second transaction initiated by the user with the second inactivated account identifier; in response to receiving the second transaction request message corresponding to the second inactivated account identifier, communicate a second credential to the user via the communication channel outside of the electronic payment processing network; receive, from the user, the second credential via the electronic payment processing network; authenticate the user based on comparing the second credential received via the electronic payment processing network to the second credential communicated to the user via the communication channel; in response to authenticating the user, activate the second account identifier; and process the transaction with the second activated account identifier after the second account identifier has been activated.

In non-limiting embodiments or aspects, the at least one server computer may be programed and/or configured to: determine the account identifier is not associated with a prior transaction request; and communicate the credential to the user in response to determining the account identifier is not associated with a prior transaction request. The at least one server computer is programed and/or configured to: search an account database for account data associated with the account identifier; determine that the account data comprises transaction data associated with a transaction request; and identify that the account identifier is not associated with the prior transaction request in response to determining the account data does not include transaction data associated with a transaction request. The at least one server computer is programed and/or configured to amend the account database to include transaction data associated with the transaction request message if the account identifier is not associated with the prior transaction request. The at least one server computer is programed and/or configured to: in response to determining the account identifier is not associated with the prior transaction request, determine if the account is registered into a transaction activation process; and in response to determining the account is registered into the transaction activation process, communicate the credential to the user.

According to other non-limiting embodiments or aspects, provided is a computer program product for processing transactions, comprising at least one non-transitory computer-readable medium including program instructions, that, when executed by at least one processor, cause the at least one processor to: register, during an enrollment process, an account for a user by associating the user with a communication channel outside of the electronic payment processing network; associate the user with an inactivated account identifier; receive, via an electronic payment processing network, a transaction request message corresponding to a transaction initiated at a merchant system by the user with a payment device issued with the inactivated account identifier; in response to receiving the transaction request message corresponding to the inactivated account identifier, communicate a credential to the user via the communication channel outside of the electronic payment processing network; receive, from the user, the credential via the electronic payment processing network; authenticate the user based on comparing the credential received via the electronic payment processing network to the credential communicated to the user via the communication channel; in response to authenticating the user, activate the account identifier; and process the transaction with the activated account identifier after the account identifier has been activated.

In non-limiting embodiments or aspects, the one or more instructions further cause the at least one processor to: determine the account associated with the user is enrolled in a transaction activation process; and communicate the credential to the user in response to determining the account is enrolled in the transaction activation process. The one or more instructions further cause the at least one processor to: associate the user with a second inactivated account identifier; receive, via the electronic payment processing network, a second transaction request message corresponding to a second transaction initiated by the user with the second inactivated account identifier; in response to receiving the second transaction request message corresponding to the second inactivated account identifier, communicate a second credential to the user via the communication channel outside of the electronic payment processing network; receive, from the user, the second credential via the electronic payment processing network; authenticate the user based on comparing the second credential received via the electronic payment processing network to the second credential communicated to the user via the communication channel; in response to authenticating the user, activate the second account identifier; and process the transaction with the second activated account identifier after the second account identifier has been activated.

In non-limiting embodiments or aspects, the one or more instructions further cause the at least one processor to: search an account database for account data associated with the account identifier; determine that the account data comprises transaction data associated with a transaction request; and identify the account identifier is not associated with the prior transaction request in response to determining the account data does not include transaction data associated with a transaction request. The one or more instructions further cause the at least one processor to, when determining the account identifier is not associated with the prior transaction request: search an account database for account data associated with the account identifier; determine that the account data comprises transaction data associated with a transaction request; and identify the account identifier is not associated with the prior transaction request in response to determining the account data does not include transaction data associated with a transaction request. The one or more instructions further cause the at least one processor to, when determining the account identifier is not associated with the prior transaction request: amend the account database to include transaction data associated with the transaction request message if the account identifier is not associated with the prior transaction request.

Further embodiments or aspects are set forth in the following numbered clauses:

Clause 1: A method comprising: registering, during an enrollment process, an account for a user by associating the user with a communication channel outside of the electronic payment processing network; associating the user with an inactivated account identifier; receiving, via an electronic payment processing network, a transaction request message corresponding to a transaction initiated at a merchant system by the user with a payment device issued with the inactivated account identifier; in response to receiving the transaction request message corresponding to the inactivated account identifier, communicating a credential to the user via the communication channel outside of the electronic payment processing network; receiving, from the user, the credential via the electronic payment processing network; authenticating the user based on comparing the credential received via the electronic payment processing network to the credential communicated to the user via the communication channel; in response to authenticating the user, activating the account identifier; and processing the transaction with the activated account identifier after the account identifier has been activated.

Clause 2: The method of clause 1, further comprising: determining the account associated with the user is enrolled in a transaction activation process; and communicating the credential to the user in response to determining the account is enrolled in the transaction activation process.

Clause 3: The method of clause 1 or 2, further comprising: associating the user with a second inactivated account identifier; receiving, via the electronic payment processing network, a second transaction request message corresponding to a second transaction initiated by the user with the second inactivated account identifier; in response to receiving the second transaction request message corresponding to the second inactivated account identifier, communicating a second credential to the user via the communication channel outside of the electronic payment processing network; receiving, from the user, the second credential via the electronic payment processing network; authenticating the user based on comparing the second credential received via the electronic payment processing network to the second credential communicated to the user via the communication channel; in response to authenticating the user, activating the second account identifier; and processing the transaction with the second activated account identifier after the second account identifier has been activated.

Clause 4: The method of any of clauses 1-3, further comprising: determining the account identifier is not associated with a prior transaction request; and communicating the credential to the user in response to determining the account identifier is not associated with a prior transaction request.

Clause 5: The method of any of clauses 1-4, wherein determining the account identifier is not associated with the prior transaction request comprises: searching an account database for account data associated with the account identifier; determining that the account data comprises transaction data associated with a transaction request; and identifying the account identifier is not associated with the prior transaction request in response to determining the account data does not include transaction data associated with a transaction request.

Clause 6: The method of any of clauses 1-5, wherein determining the account identifier is not associated with the prior transaction request further comprises: amending the account database to include transaction data associated with the transaction request message if the account identifier is not associated with the prior transaction request.

Clause 7: The method of any of clauses 1-6, further comprising: in response to determining the account identifier is not associated with the prior transaction request, determining if the account is registered into a transaction activation process; and in response to determining the account is registered into the transaction activation process, communicating the credential to the user.

Clause 8: A system for processing transactions, the system comprising at least one server computer including at least one processor, the at least one server computer programmed and/or configured to: register, during an enrollment process, an account for a user by associating the user with a communication channel outside of the electronic payment processing network; associate the user with an inactivated account identifier; receive, via an electronic payment processing network, a transaction request message corresponding to a transaction initiated at a merchant system by the user with a payment device issued with the inactivated account identifier; in response to receiving the transaction request message corresponding to the inactivated account identifier, communicate a credential to the user via the communication channel outside of the electronic payment processing network; receive, from the user, the credential via the electronic payment processing network; authenticate the user based on comparing the credential received via the electronic payment processing network to the credential communicated to the user via the communication channel; in response to authenticating the user, activate the account identifier; and process the transaction with the activated account identifier after the account identifier has been activated.

Clause 9: The system of clause 8, wherein the at least one server computer is programed and/or configured to: determine the account associated with the user is enrolled in a transaction activation process; and communicate the credential to the user in response to determining the account is enrolled in the transaction activation process.

Clause 10: The system of clause 8 or 9, wherein the at least one server computer is programed and/or configured to: associate the user with a second inactivated account identifier; receive, via the electronic payment processing network, a second transaction request message corresponding to a second transaction initiated by the user with the second inactivated account identifier; in response to receiving the second transaction request message corresponding to the second inactivated account identifier, communicate a second credential to the user via the communication channel outside of the electronic payment processing network; receive, from the user, the second credential via the electronic payment processing network; authenticate the user based on comparing the second credential received via the electronic payment processing network to the second credential communicated to the user via the communication channel; in response to authenticating the user, activate the second account identifier; and process the transaction with the second activated account identifier after the second account identifier has been activated.

Clause 11: The system of any of clauses 8-10, wherein the at least one server computer is programed and/or configured to: determine the account identifier is not associated with a prior transaction request; and communicate the credential to the user in response to determining the account identifier is not associated with a prior transaction request.

Clause 12: The system of any of clauses 8-11, wherein the at least one server computer is programed and/or configured to: search an account database for account data associated with the account identifier; determine that the account data comprises transaction data associated with a transaction request; and identify the account identifier is not associated with the prior transaction request in response to determining the account data does not include transaction data associated with a transaction request.

Clause 13: The system of any of clauses 8-12, wherein the at least one server computer is programed and/or configured to: amend the account database to include transaction data associated with the transaction request message if the account identifier is not associated with the prior transaction request.

Clause 14: The system of any of clauses 8-13, wherein the at least one server computer is programed and/or configured to: in response to determining the account identifier is not associated with the prior transaction request, determine if the account is registered into a transaction activation process; and in response to determining the account is registered into the transaction activation process, communicate the credential to the user.

Clause 15: A computer program product for processing transactions, comprising at least one non-transitory computer-readable medium including program instructions, that, when executed by at least one processor, cause the at least one processor to: register, during an enrollment process, an account for a user by associating the user with a communication channel outside of the electronic payment processing network; associate the user with an inactivated account identifier; receive, via an electronic payment processing network, a transaction request message corresponding to a transaction initiated at a merchant system by the user with a payment device issued with the inactivated account identifier; in response to receiving the transaction request message corresponding to the inactivated account identifier, communicate a credential to the user via the communication channel outside of the electronic payment processing network; receive, from the user, the credential via the electronic payment processing network; authenticate the user based on comparing the credential received via the electronic payment processing network to the credential communicated to the user via the communication channel; in response to authenticating the user, activate the account identifier; and process the transaction with the activated account identifier after the account identifier has been activated.

Clause 16: The computer program product of clause 15, wherein the one or more instructions further cause the at least one processor to: determine the account associated with the user is enrolled in a transaction activation process; and communicate the credential to the user in response to determining the account is enrolled in the transaction activation process.

Clause 17: The computer program product of clause 15 or 16, wherein the one or more instructions further cause the at least one processor to: associate the user with a second inactivated account identifier; receive, via the electronic payment processing network, a second transaction request message corresponding to a second transaction initiated by the user with the second inactivated account identifier; in response to receiving the second transaction request message corresponding to the second inactivated account identifier, communicate a second credential to the user via the communication channel outside of the electronic payment processing network; receive, from the user, the second credential via the electronic payment processing network; authenticate the user based on comparing the second credential received via the electronic payment processing network to the second credential communicated to the user via the communication channel; in response to authenticating the user, activate the second account identifier; and process the transaction with the second activated account identifier after the second account identifier has been activated.

Clause 18: The computer program product of any of clauses 15-17, wherein the one or more instructions further cause the at least one processor to: search an account database for account data associated with the account identifier; determine that the account data comprises transaction data associated with a transaction request; and identify the account identifier is not associated with the prior transaction request in response to determining the account data does not include transaction data associated with a transaction request.

Clause 19: The computer program product of any of clauses 15-18, wherein the one or more instructions further cause the at least one processor to, when determining the account identifier is not associated with the prior transaction request: search an account database for account data associated with the account identifier; determine that the account data comprises transaction data associated with a transaction request; and identify the account identifier is not associated with the prior transaction request in response to determining the account data does not include transaction data associated with a transaction request.

Clause 20: The computer program product of any of clauses 15-19, wherein the one or more instructions further cause the at least one processor to, when determining the account identifier is not associated with the prior transaction request: amend the account database to include transaction data associated with the transaction request message if the account identifier is not associated with the prior transaction request.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments that are illustrated in the accompanying schematic figure and appendices, in which:

FIG. 1 is a schematic diagram of a system for card activation according to a non-limiting embodiment;

FIG. 2 is a sequence diagram of a method of card activation according to non-limiting embodiments;

FIG. 3 is a flow diagram of a method for card activation according to a non-limiting embodiment; and

FIG. 4 is a schematic diagram of example components of a computing device according to non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

The term “account data,” as used herein, refers to any data concerning one or more accounts for one or more users. Account data may include, for example, one or more account identifiers, user identifiers, transaction histories, balances, credit limits, issuer institution identifiers, and/or the like.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant. For example, a merchant system may include a point-of-sale (POS) system, a server computer executing one or more software applications, and/or the like. In some examples, a merchant system may be a server computer configured to process electronic transactions received through a merchant webpage. In other examples, a merchant system may be a physical POS system associated with a brick-and-mortar merchant. A “point-of-sale (POS) system,” as used herein, may refer to one or more computers and/or peripheral devices used by a merchant to engage in payment transactions with customers and/or process a transaction, including one or more card readers, peripheral devices, scanning devices (e.g., code scanners), Bluetooth® communication receivers, near-field communication (NFC) receivers, radio frequency identification (RFID) receivers, and/or other contactless transceivers or receivers, contact-based receivers, payment terminals, computers, servers, input devices, and/or other like devices that can be used to initiate a Card Present and/or a Card Not Present payment transaction.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, an electronic payment processing network may refer to the communications between one or more entities for processing the transfer of monetary funds related to one or more transactions. The electronic processing network may include a merchant system, an acquirer system, a transaction service provider, and an issuer system.

Non-limiting embodiments described herein are directed to a system, method, and computer program product for card activation. Many resources are utilized to combat fraud in the use of credit cards. Fraudsters may be able to intercept credit cards intended to be sent to customers and use the credit cards themselves to make fraudulent purchases. Typically, credit cards can be activated by calling a hotline or may be activated automatically. Non-limiting embodiments described herein provide a unique arrangement and architecture that allows card activation to occur during the first transaction, resulting in a reduction in used resources and an increase in security. The reduction in resources may be achieved because the call centers or hotlines for card activation may no longer be necessary. This means that issuer institutions no longer need to maintain the hotline for card activations. By interacting with the customer through different communication channels to activate an account concurrent with a payment transaction, non-limiting embodiments provide an additional layer of assurance that the user is the individual who initiated a transaction and reduces the possibility that the initial transaction is fraudulent. If interaction with the user fails, the transaction can quickly be considered fraudulent and the account can be appropriately labeled as being fraudulent, quickly preventing additional cases of fraud for the account.

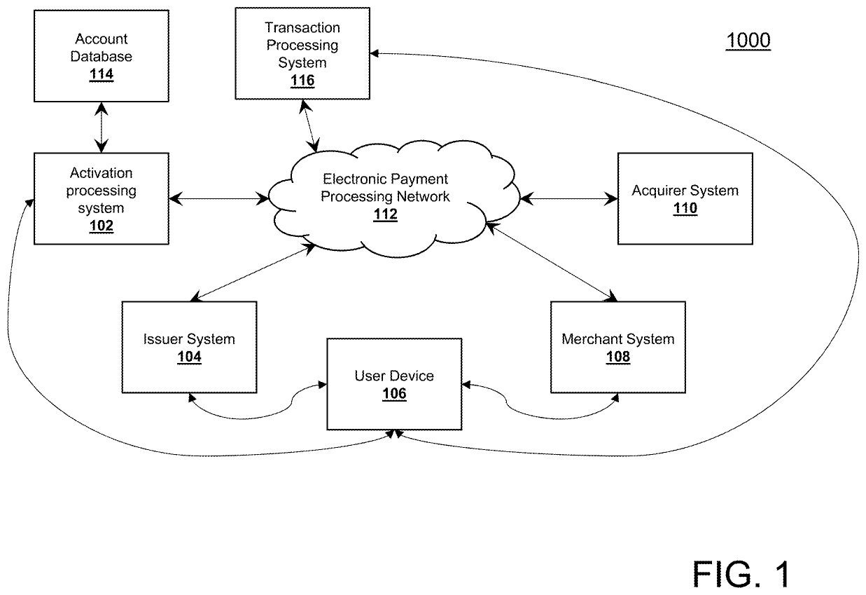

Referring now to FIG. 1, shown is a system 1000 for card activation according to a non-limiting embodiment. The system 1000 includes an activation processing system 102, an issuer system 104, a user device 106, a merchant system 108, an acquirer system 110, and a transaction processing system 116. The activation processing system 102, issuer system 104, user device 106, merchant system 108, acquirer system 110, and transaction processing system 116 may each include one or more computing devices configured to communicate through one or more communication networks, such as an electronic payment processing network 112. In non-limiting embodiments or aspects, the activation processing system 102 may be a component of the transaction processing system 116, a component of the issuer system 104, or a separate system.

With continued reference to FIG. 1, a user may request enrollment in an account with an issuer, such as an account for a payment device (e.g. a credit card, debit card, electronic payment device, and/or the like). The user may request enrollment in the account using a user device 106. The user device 106 may communicate the enrollment request to the issuer through the issuer system 104. Enrollment may be requested through a website, a mobile application, text message, email, and/or the like. In some non-limiting embodiments, an enrollment request may be communicated to the issuer through physical mail, a phone call, and/or the like.

With continued reference to FIG. 1, during the enrollment process, the user may be registered to an account and the account may be associated with a communication channel that is located outside of the electronic payment processing network 112 (e.g., a network including an issuer system and an acquirer system for processing payments associated with a transaction). The communication channel may include a contact method, such as a phone number, an email address, a physical address, an Internet Protocol (IP) or other network address, and/or the like. The communication channel may also include a mobile application, such as a push message provided by an application on the user device 106. The communication channel may be provided by the user. The communication channel may allow the user device 106 to communicate with the transaction processing system 116, merchant system 108, issuer system 104, and/or activation processing system 102. The account associated with the user may include an inactive account identifier. An inactive account identifier may refer to an account identifier that is associated with an “inactive” status that cannot be used to process a transaction until it is activated according to a specified procedure.

In non-limiting embodiments, the user may register the account to be activated via a transaction activation process. For example, the user may specify a preference in the enrollment request and/or may select one or more selectable options during the enrollment process. In other examples, the account may automatically be enrolled in a manner such that it is activated via a transaction activation process. In a transaction activation process, activation of the inactivated account identifier may be initiated in response to the first use of the account identifier, such as the first transaction (e.g., a purchase at a merchant) attempted with the inactive account identifier.

With continued reference to FIG. 1, the issuer system 104 may communicate at least one activation option to the user device 106 for activating the inactive account identifier, such as a One Time Password (OTP), calling or receiving a call from a call center, a URL, automatic activation (e.g., the account identifier is automatically activated upon the first transaction), and/or the like. The user may select one of the activation options and communicate the selection to the issuer. The selection may be communicated from the user device 106 to the issuer system 104. In some non-limiting embodiments or aspects, a predetermined activation option may be automatically selected upon registering the account to the transaction activation process. The activation option may be initiated in response to receiving a transaction request. The issuer system 104 may store the selected activation option into the account settings (e.g., activation option, account profile, etc.) associated with the account identifier in an activation option database.

With continued reference to FIG. 1, in response to selecting an activation option, or registering the account with the transaction activation process, the issuer may issue a payment device to the user. The payment device is issued with the inactivated account identifier. The payment device may be delivered to the user as a physical card, such as through the mail, courier, or other method of physical delivery. In some non-limiting embodiments, the payment device may be delivered to the user electronically, such as a token representing the inactivated account identifier provisioned to an electronic wallet. It will be appreciated that the payment device including the inactivated account identifier may be issued to the user in various ways.

With continued reference to FIG. 1, a user may initiate a transaction at a merchant with the inactivated account identifier. The user may initiate the transaction at the merchant system 108, such as a POS device, with the inactivated account identifier. The merchant system 108 may generate a transaction request message corresponding to the transaction initiated at the merchant system 108 by the user.

With continued reference to FIG. 1, the merchant system 108 may communicate the transaction request message, including the inactivated account identifier, to the activation processing system 102 via an electronic payment processing network 112. The merchant system 108 may communicate the transaction request message to the acquirer system 110 or a payment gateway (not shown in FIG. 1). The acquirer system 110 (or payment gateway) may communicate the transaction request to the activation processing system 102 or the transaction processing system 116. In response to receiving the transaction request, the transaction processing system 116 may communicate the transaction request to the activation processing system 102. The merchant system 108, acquirer system 110, transaction processing system 116, and activation processing system 102 may communicate through the electronic payment processing network 112.

With continued reference to FIG. 1, in response to receiving the transaction request message, the activation processing system 102 may initiate the communication of a credential to the user via the communication channel outside of the electronic payment processing network 112. The credential may be random, numeric, alphanumeric, and/or the like. The activation processing system 102 may first determine if the user associated with the inactivated account identifier is enrolled in the transaction activation process. If the user is not enrolled in the transaction activation process, the activation processing system 102 or the transaction processing system 116 may communicate the transaction request to the issuer system 104 for approval. In some non-limiting embodiments or aspects, in response to determining the account is enrolled in the transaction activation process, the credential may be communicated to the user.

With continued reference to FIG. 1, if the user is enrolled in the transaction activation process, the activation processing system 102 may determine if the transaction request is the first time that the account identifier has been associated with a transaction request. The activation processing system 102 may check an account database. The account database 114 may in communication with or part of a server associated with the activation processing system 102 or may be accessible via a server associated with a third party. The account database 114 may include account data associated with each account identifier. The account data may include an entry for the expiration date, verification code (e.g., card verification value (CVV), integrated chip card verification value (ICVV), dynamic card verification value (dCVV), card verification value 2 (CVV2), and/or the like), cryptogram, first use indicator, OTP, credential, and/or the like for each account identifier. The first use indicator may include a flag, variable, and/or any other indicator to represent that the account identifier has received a first use or not. The first use indicator may be used by the activation processing system 102 to determine that the account identifier has received a first use or not. The first use of the account identifier may include a transaction initiated with the payment device including the account identifier. The account database 114 may include information associated with the first use of the account identifier, such as date, time, merchant, location, and/or the like of the first use of the account identifier. It may be determined that the account identifier associated with the transaction request is a first time use if the account database 114 indicates that there has not yet been a first time use, e.g. the first use flag indicates first use has not yet occurred. In some non-limiting embodiments or aspects, it may be determined that the account identifier associated with the transaction request is being used for the first time if the account database 114 does not include any transaction data.

With continued reference to FIG. 1, in some non-limiting embodiments or aspects, if the account identifier is associated with a prior transaction or is determined to not be a first time use (e.g., a second use, third use, etc.), the activation processing system 102 may communicate the transaction to the issuer system 104 for approval. In non-limiting embodiments or aspects, the activation processing system 102 may communicate the transaction to the transaction processing system 116. The transaction processing system 116 may communicate the transaction to the issuer system 104 for approval.

With continued reference to FIG. 1, in some non-limiting embodiments or aspects, in response to determining that the account identifier is being used for the first time in the transaction associated with the transaction request, the activation processing system 102 may determine the activation option associated with the account identifier. In some non-limiting embodiments, the activation processing system 102 may communicate a request to the issuer system 104 to determine the activation option associated with the account identifier. The issuer system 104 may retrieve the activation option from the account settings associated with the account identifier located in the activation option database. In response to determining the account identifier is being used for the first time in the transaction, the account database 114 may be modified to store transaction data associated with the transaction request message.

With continued reference to FIG. 1, in some non-limiting embodiments or aspects, the activation processing system 102 may communicate with the issuer system 104 through an Application Programming Interface (API). In some non-limiting embodiments or aspects, the activation processing system may communicate the account identifier, a date and/or time of the transmission, a security code, an activation option request, and/or the like to the issuer system 104. In some non-limiting embodiments, in response to receiving the activation option request, the issuer system 104 may communicate the activation option associated with the account identifier to the activation processing system 102.

With continued reference to FIG. 1, in some non-limiting embodiments or aspects, if the activation option associated with the account identifier is a credential (e.g., an OTP and/or the like), the activation processing system 102 may generate the credential. In some non-limiting embodiments, in response to generating the credential, the activation processing system 102 may update the account database 114 to indicate that a credential has been generated for the account identifier. The activation processing system 102 and/or the transaction processing system 116 may also update the account database 114 with the generated credential. The activation processing system 102 may communicate the credential to the issuer system 104 or the transaction processing system 116. In some non-limiting embodiments or aspects, the credential may be generated by the issuer system 104. The issuer system 104 may generate the credential at enrollment or in response to receiving the activation option request.

With continued reference to FIG. 1, in some non-limiting embodiments or aspects, the issuer system 104, activation processing system 102, or transaction processing system 116 may communicate the credential to the user. The communication to the user may be outside of the electronic payment processing network 112 utilizing the communication channel provided by the user. The credential may be communicated to the user device 106. The credential may be communicated to the user through email, SMS, MMS, an automated phone call, push notification to a mobile application, and/or the like. In some non-limiting embodiments or aspects, the activation processing system 102 may communicate the credential to the user or user device 106.

With continued reference to FIG. 1, in some non-limiting embodiments or aspects, in response to generating the credential, the activation processing system 102 may communicate the activation option associated with the account identifier to the acquirer system 110 (or payment gateway). In response to generating the credential, the activation processing system 102 may amend the account database 114 to indicate that a credential has been generated for the account identifier. The acquirer system 110 (or payment gateway) may communicate the activation option to the merchant system 108. In some non-limiting embodiments or aspects, the activation processing system 102 may communicate the activation option directly to the merchant system 108 and/or may communicate the activation option to the merchant system 108 in a manner that does not involve the acquirer system 110. In response to receiving the activation option, the merchant system 108 may alter a display of the POS terminal such that the POS terminal is configured to receive the activation option and/or credential from the user.

With continued reference to FIG. 1, in some non-limiting embodiments or aspects, the activation processing system 102 may communicate terms and conditions with the activation option to the user via the merchant system 108 or via the user device 106. The merchant system 108 or user device 106 may communicate or display the activation option and/or the terms and conditions to the user. The activation option and/or terms and conditions may be displayed on a POS terminal. The user may be required to accept the terms and conditions in order to activate the account identifier. The user may enter a response to the terms and conditions into the POS terminal or the user device 106.

With continued reference to FIG. 1, in some non-limiting embodiments or aspects, the user may be required to communicate the credential directly or indirectly to the activation processing system 102 in order to activate the account identifier. The user may communicate the credential to the merchant system 108 such as by entering the credential into the POS terminal, or through the user device 106, such as through a website, mobile application, text message, email, and/or the like. The user may be prompted to enter the credential into the POS terminal. The POS terminal may prompt the user to enter the credential in response to receiving the activation option. In non-limiting embodiments or aspects, the user may communicate the credential to the activation processing system 102 or transaction processing system 116 via the user device 106.

With continued reference to FIG. 1, in some non-limiting embodiments or aspects, the credential and/or response to the terms and conditions may be communicated to the activation processing system 102 through the electronic payment processing network 112, such as through the merchant system 108, acquirer system 110, and/or issuer system 104. The merchant system 108 may communicate the credential and/or the response to the terms and conditions received from the user to the acquirer system 110. In some non-limiting embodiments or aspects, the credential may be embedded into the response to the terms and conditions such that the credential and response to the terms and conditions are received in a single message. In some non-limiting embodiments or aspects, the credential may be embedded into a transaction request message or an authorization message, such as an ISO 8583 formatted message. The acquirer system 110 may communicate the credential and/or response to the terms and conditions to the activation processing system 102 or the transaction processing system 116. The transaction processing system 116 may communicate the credential and/or response to the terms and conditions to the activation processing system 102. The OTP may be communicated as part of the authorization message or transaction request.

With continued reference to FIG. 1, in some non-limiting embodiments or aspects, in response to receiving the credential, the activation processing system 102 may authenticate the user based on the credential. The activation processing system 102 may determine if the account identifier associated with the credential is enrolled in the transaction activation process. If the account identifier is not enrolled in the transaction activation process, the transaction may be communicated to the issuer system 104.

With continued reference to FIG. 1, in some non-limiting embodiments or aspects, if it is determined that the account identifier is enrolled in the transaction activation process, the activation processing system 102 may check the account database 114 to determine if a credential associated with the account identifier has been generated. In response to determining that a credential has been generated for the account identifier, the activation processing system 102 may compare the generated credential communicated to the user via the communication channel to the credential received from the merchant system 108 via the electronic payment processing network 112, or received directly or indirectly from the user. If it is determined that the generated credential matches the credential received from the merchant system 108, the credential may be validated. In response to validating the credential, the account identifier may be activated. The activation processing system 102 may communicate the transaction and/or validation to the issuer system 104. In response to receiving the transaction and/or validation from the activation processing system 102, the issuer system 104 may activate the account identifier associated with the transaction or validation. The transaction may be processed with the activated account identifier after the account identifier has been activated.

With continued reference to FIG. 1, in some non-limiting embodiments or aspects, if authentication fails (e.g., the credential communicated through the communication channel does not match the credential received via the electronic payment processing network 112), then the activation processing system 102 may communicate the failed authentication to the issuer system 104. In response to the failed authentication, the activation processing system 102 or the issuer system 104 may flag the account identifier as being fraudulent. The issuer system 104 may update a fraud model based on the failed authentication. Updating the fraud model may indicate that the account identifier has likely been used in a fraudulent transaction and transaction with the account identifier should not be processed. In some non-limiting embodiments or aspects, the authentication may fail if the credential is not received by the activation processing system 102 within a predetermined period of time. In some non-limiting embodiments or aspects, after a single failed authentication, after a predetermined number of failed authentications, or after expiration of a predetermined time period, another credential may be automatically generated and communicated to the user. The user may communicate the new credential to the activation processing system 102 to allow for multiple attempts at authentication.

With continued reference to FIG. 1, in some non-limiting embodiments or aspects, the activation option selected by the user may be automatically applied to future account identifiers. When an account identifier expires or is approaching expiration, the user may be issued a new account identifier. The activation option may be associated with the account of the user such that each subsequent account identifier automatically shares the same activation option. Therefore, if a new inactivated account identifier is associated with the user after the original inactivated account identifier, it may have the same activation option as the first account identifier for which this option was chosen. The new account identifier may be issued to the user and the user may initiate a new transaction with the new account identifier with a merchant system 108. The activation processing system 102 may receive a new transaction request message associated with the new transaction via the electronic payment processing network 112. In response to receiving the second transaction request message, the activation processing system 102 may initiate the communication of a new credential to the user via the communication channel outside the electronic payment processing network 112. Upon receiving the new credential, the user may communicate the new credential to the activation processing system 102 via the electronic payment processing network 112. The user's new account identifier may be authenticated by comparing the credential communicated via the communication channel to the credential received from the electronic payment processing network 112. If the credentials match, the credential may be validated and the user may be authenticated. In response to authenticating the user, the new account identifier may be activated. Once activated, the new transaction may be processed with the new account identifier.

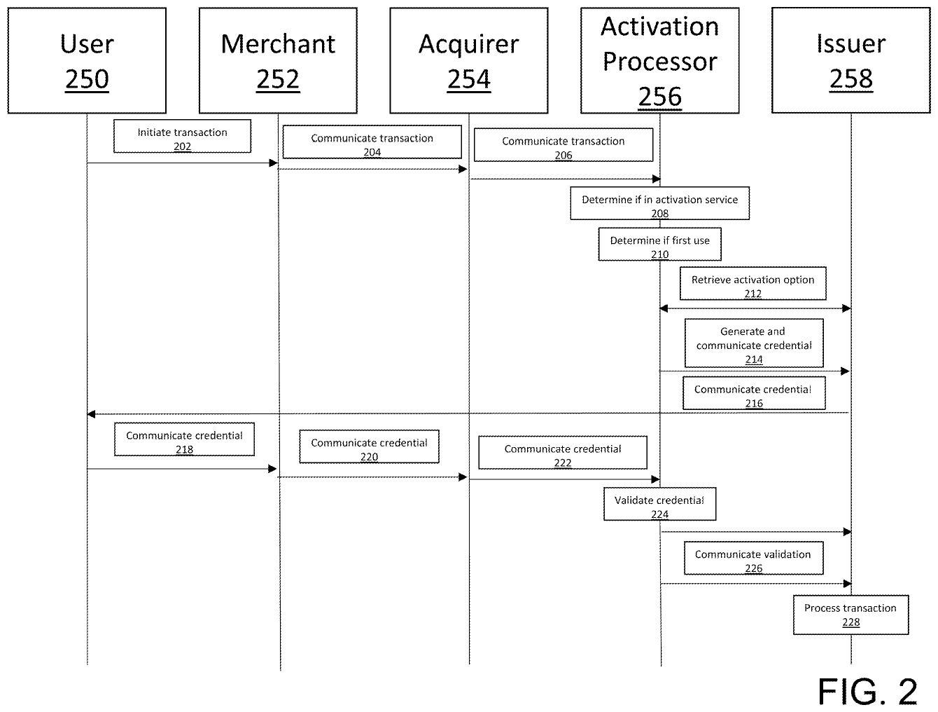

Referring now to FIG. 2, shown is a sequence diagram of a method of activating an account identifier in non-limiting embodiments or aspects. In step 202 a user 250 initiates a transaction at a merchant 252 using an inactivated account identifier. In step 204, the merchant 252 may communicate the transaction to the acquirer 254 through a transaction request message. In step 206, the acquirer 254 may communicate the transaction request message to the activation processor 256.

With continued reference to FIG. 2, in non-limiting embodiments or aspects, in step 208, the activation processor 256 may check the account data of the user associated with the transaction to determine if the user is a participant in the transaction activation process. The settings of the user may be stored in an account database. In step 210, the activation processor 256 may determine if the account identifier associated with the transaction request message is being used in a transaction for the first time. The activation processor 256 may determine if it is the first use based on the account data located in the account database.

With continued reference to FIG. 2, in non-limiting embodiments or aspects, in step 212 the activation processor may retrieve the activation option associated with the account of the user. The activation processor 256 may request the activation option from an issuer 258. The issuer 258 may communicate the activation option to the activation processor 256 in response to receiving the activation option request. If the activation option indicates that the user has selected to activate the account identifier at a transaction through a credential, the activation processor 256 will generate the credential in step 214 and communicate the credential to the issuer 258. The issuer 258 may then communicate the credential to the user 250 utilizing the method of communication (e.g., email, text message, phone call, application notification, etc.) specified by the user 250 in the account.

With continued reference to FIG. 2, in non-limiting embodiments or aspects, after the user 250 receives the credential, in step 218 the user 250 will communicate the credential to the merchant 252. In step 220, the merchant will communicate the credential to the acquirer 254. The acquirer may then communicate the credential to the activation processor 256 in step 222.

With continued reference to FIG. 2, in non-limiting embodiments or aspects, when the activation processor 256 receives the credential, the activation processor 256 may validate the credential and authenticate the user 250 in response to validating the credential in step 224. The activation processor may authenticate the user 250 by comparing the credential sent to the issuer 258 with the credential received from the user 250. If the two credentials match, the activation processor 256 may validate the credential and authenticate the user 250. Once validated, the activation processor 256 may communicate the validation and/or authentication to the issuer 258 in step 226. In step 228, the issuer may activate the account identifier associated with the user 250 in response to receiving the credential validation and may process the transaction.

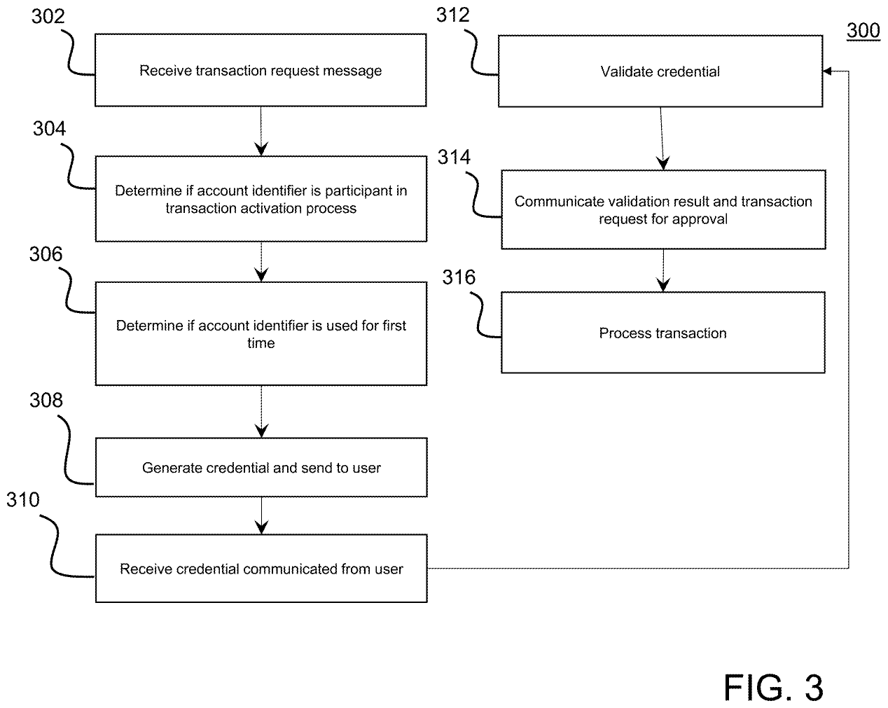

Referring now to FIG. 3, shown is a flow chart of an example method of activating an inactive account identifier based on a transaction in non-limiting embodiments or aspects that may be performed by an issuer system, activation processing system, transaction system, and/or the like. It will be appreciated that additional steps, different steps, and/or a different order of steps may be used in non-limiting embodiments, and that the non-limiting embodiment shown in FIG. 3 is for example purposes. In step 302, a transaction request message is received. The transaction request message contains an account identifier and may be received from a merchant system, such as merchant website, a POS terminal, and/or the like, associated with either a Card Present transaction (e.g., at a brick and mortar merchant) or a Card Not Present transaction (e.g., at an online merchant). In step 304, the account identifier is checked to determine if the account identifier is associated with a user that has elected to enroll in a transaction activation process in which an inactivated account identifier may be activated based on a transaction request message. The account data associated with the account identifier or user may be accessed in an account database to determine if the transaction activation process has been selected.

With continued reference to FIG. 3, in non-limiting embodiments or aspects, in step 306 it is determined the transaction request message is the first time the account identifier has been associated with a transaction request message. In step 308, if it is the first time the account identifier has been associated with a transaction request, a credential may be generated and sent to the user associated with the account identifier. The type of credential and the method of delivery to the user may be predetermined. The user may select the preferred credential and delivery method when enrolling in an account or prior to using the inactivated account identifier. The delivery method may be outside of the electronic payment processing network.

With continued reference to FIG. 3, in non-limiting embodiments or aspects, a credential may be received from the user at step 310. The credential may be received through the electronic payment processing network. The credential may be validated in step 312 to ensure that the credential received from the user matches the credential communicated to the user. Validation may include generating a validation result or validation data based on the results of the comparison of the credential received from the user and the credential communicated to the user. In response to the validation, the validation result and the transaction request may be communicated to an issuer in step 314. If the issuer approves of the transaction request, then the issuer can process the transaction associated with the transaction request in step 316.

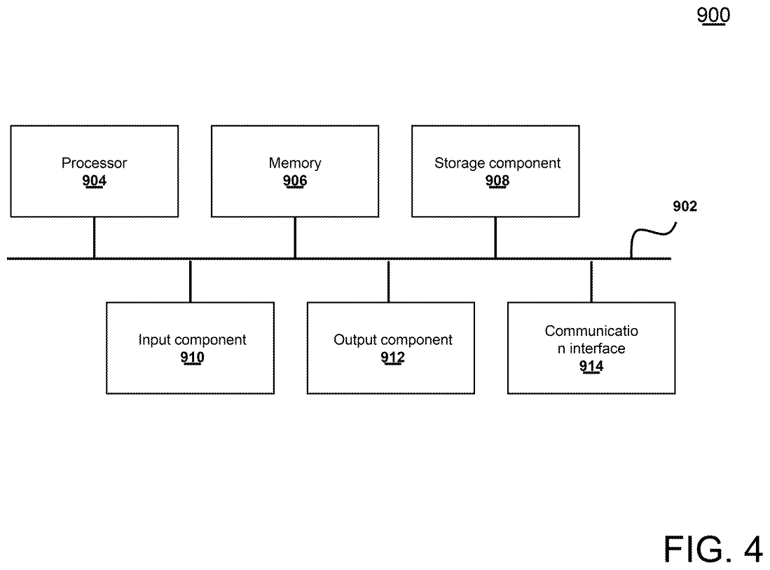

Referring now to FIG. 4, shown is a diagram of example components of a computing device 900 for implementing and performing the systems and methods described herein according to non-limiting embodiments. The computing device 900 may refer to the activation processing system 102, issuer system 104, user device 106, merchant system 108, acquirer system 110, or account database 114 shown in FIG. 1. In some non-limiting embodiments, device 900 may include additional components, fewer components, different components, or differently arranged components than those shown in FIG. 4. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), virtual or augmented reality depicting systems and devices, etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 4, storage component 908 may store information and/or software related to the operation and use of device 900. For example, storage component 908 may include a hard disk (e.g., a magnetic disk, an optical disk, a magneto-optic disk, a solid-state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method comprising:
registering, during an enrollment process, an account for a user by associating the user with a communication channel outside of an electronic payment processing network;
associating the user with an inactivated account identifier;
receiving, via the electronic payment processing network, a transaction request message corresponding to a transaction initiated at a merchant system by the user with a payment device issued with the inactivated account identifier;
in response to receiving the transaction request message corresponding to the inactivated account identifier, communicating a credential to the user via the communication channel outside of the electronic payment processing network;
receiving, from the user, the credential via the electronic payment processing network;
authenticating the user based on comparing the credential received via the electronic payment processing network to the credential communicated to the user via the communication channel;
in response to authenticating the user, activating the account identifier; and
processing the transaction with the activated account identifier after the account identifier has been activated.

2. The method of claim 1, further comprising:
determining the account associated with the user is enrolled in a transaction activation process; and
communicating the credential to the user in response to determining the account is enrolled in the transaction activation process.

3. The method of claim 2, further comprising:
associating the user with a second inactivated account identifier;
receiving, via the electronic payment processing network, a second transaction request message corresponding to a second transaction initiated by the user with the second inactivated account identifier;
in response to receiving the second transaction request message corresponding to the second inactivated account identifier, communicating a second credential to the user via the communication channel outside of the electronic payment processing network;
receiving, from the user, the second credential via the electronic payment processing network;
authenticating the user based on comparing the second credential received via the electronic payment processing network to the second credential communicated to the user via the communication channel;
in response to authenticating the user, activating the second account identifier; and
processing the transaction with the second activated account identifier after the second account identifier has been activated.

4. The method of claim 1, further comprising:
determining the account identifier is not associated with a prior transaction request; and
communicating the credential to the user in response to determining the account identifier is not associated with the prior transaction request.

5. The method of claim 4, wherein determining the account identifier is not associated with the prior transaction request comprises:
searching an account database for account data associated with the account identifier;
determining that the account data comprises transaction data associated with a transaction request; and
identifying the account identifier is not associated with the prior transaction request in response to determining the account data does not include transaction data associated with a transaction request.

6. The method of claim 5, wherein determining the account identifier is not associated with the prior transaction request further comprises:
amending the account database to include transaction data associated with the transaction request message if the account identifier is not associated with the prior transaction request.

7. The method of claim 5, further comprising:
in response to determining the account identifier is not associated with the prior transaction request, determining if the account is registered to a transaction activation process; and
in response to determining the account is registered to the transaction activation process, communicating the credential to the user.

8. A system for processing transactions, the system comprising at least one server computer including at least one processor, the at least one server computer programmed and/or configured to:
register, during an enrollment process, an account for a user by associating the user with a communication channel outside of an electronic payment processing network;
associate the user with an inactivated account identifier;
receive, via the electronic payment processing network, a transaction request message corresponding to a transaction initiated at a merchant system by the user with a payment device issued with the inactivated account identifier;
in response to receiving the transaction request message corresponding to the inactivated account identifier, communicate a credential to the user via the communication channel outside of the electronic payment processing network;
receive, from the user, the credential via the electronic payment processing network;
authenticate the user based on comparing the credential received via the electronic payment processing network to the credential communicated to the user via the communication channel;
in response to authenticating the user, activate the account identifier; and
process the transaction with the activated account identifier after the account identifier has been activated.

9. The system of claim 8, wherein the at least one server computer is programmed and/or configured to:
determine the account associated with the user is enrolled in a transaction activation process; and
communicate the credential to the user in response to determining the account is enrolled in the transaction activation process.

10. The system of claim 9, wherein the at least one server computer is programmed and/or configured to:
associate the user with a second inactivated account identifier;
receive, via the electronic payment processing network, a second transaction request message corresponding to a second transaction initiated by the user with the second inactivated account identifier;
in response to receiving the second transaction request message corresponding to the second inactivated account identifier, communicate a second credential to the user via the communication channel outside of the electronic payment processing network;
receive, from the user, the second credential via the electronic payment processing network;
authenticate the user based on comparing the second credential received via the electronic payment processing network to the second credential communicated to the user via the communication channel;
in response to authenticating the user, activate the second account identifier; and
process the transaction with the second activated account identifier after the second account identifier has been activated.

11. The system of claim 8, wherein the at least one server computer is programmed and/or configured to:
determine the account identifier is not associated with a prior transaction request; and
communicate the credential to the user in response to determining the account identifier is not associated with the prior transaction request.

12. The system of claim 11, wherein the at least one server computer is programmed and/or configured to:
search an account database for account data associated with the account identifier;
determine that the account data comprises transaction data associated with a transaction request; and
identify the account identifier is not associated with the prior transaction request in response to determining the account data does not include transaction data associated with a transaction request.

13. The system of claim 12, wherein the at least one server computer is programmed and/or configured to:
amend the account database to include transaction data associated with the transaction request message if the account identifier is not associated with the prior transaction request.

14. The system of claim 12, wherein the at least one server computer is programmed and/or configured to:
in response to determining the account identifier is not associated with the prior transaction request, determine if the account is registered to a transaction activation process; and
in response to determining the account is registered to the transaction activation process, communicate the credential to the user.

15. A computer program product for processing transactions, comprising at least one non-transitory computer-readable medium including program instructions that, when executed by at least one processor, cause the at least one processor to:
register, during an enrollment process, an account for a user by associating the user with a communication channel outside of an electronic payment processing network;
associate the user with an inactivated account identifier;
receive, via the electronic payment processing network, a transaction request message corresponding to a transaction initiated at a merchant system by the user with a payment device issued with the inactivated account identifier;
in response to receiving the transaction request message corresponding to the inactivated account identifier, communicate a credential to the user via the communication channel outside of the electronic payment processing network;
receive, from the user, the credential via the electronic payment processing network;
authenticate the user based on comparing the credential received via the electronic payment processing network to the credential communicated to the user via the communication channel;
in response to authenticating the user, activate the account identifier; and
process the transaction with the activated account identifier after the account identifier has been activated.

16. The computer program product of claim 15, wherein the one or more instructions further cause the at least one processor to:
determine the account associated with the user is enrolled in a transaction activation process; and
communicate the credential to the user in response to determining the account is enrolled in the transaction activation process.

17. The computer program product of claim 16, wherein the one or more instructions further cause the at least one processor to:
associate the user with a second inactivated account identifier;
receive, via the electronic payment processing network, a second transaction request message corresponding to a second transaction initiated by the user with the second inactivated account identifier;
in response to receiving the second transaction request message corresponding to the second inactivated account identifier, communicate a second credential to the user via the communication channel outside of the electronic payment processing network;
receive, from the user, the second credential via the electronic payment processing network;
authenticate the user based on comparing the second credential received via the electronic payment processing network to the second credential communicated to the user via the communication channel;
in response to authenticating the user, activate the second account identifier; and
process the transaction with the second activated account identifier after the second account identifier has been activated.

18. The computer program product of claim 15, wherein the one or more instructions further cause the at least one processor to:
search an account database for account data associated with the account identifier;
determine that the account data comprises transaction data associated with a transaction request; and
identify the account identifier is not associated with the prior transaction request in response to determining the account data does not include transaction data associated with a transaction request.

19. The computer program product of claim 18, wherein the one or more instructions further cause the at least one processor to, when determining the account identifier is not associated with the prior transaction request:
search an account database for account data associated with the account identifier;
determine that the account data comprises transaction data associated with a transaction request; and
identify the account identifier is not associated with the prior transaction request in response to determining the account data does not include transaction data associated with a transaction request.

20. The computer program product of claim 19, wherein the one or more instructions further cause the at least one processor to, when determining the account identifier is not associated with the prior transaction request:
amend the account database to include transaction data associated with the transaction request message if the account identifier is not associated with the prior transaction request.
